(19) United States
(12) Patent Application Publication
(10) Pub. No.: US 2005/0025871 A1
(43) Pub. Date: Feb. 3, 2005

(54) Spreadable butter product

(76) Inventor: Legi Gil Shoshan, Wellington, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/870,735

(22) Filed: Jun. 17, 2004

Related U.S. Application Data
(60) Provisional application No. 60/479,040, filed on Jun. 17, 2003.

(51) Int. Cl. A23L 1/00

(52) U.S. Cl. 426/581

(57) ABSTRACT

A spreadable butter product and package for handling an individual service portion of spreadable butter, including the steps of heating, aerating, and adding a preservative to the butter product and placing the butter contents into a packet in between at least two laminate layers of a material capable of being heat sealed to form individual packets of individual servings of butter.

### TECHNICAL FIELD OF THE INVENTION

The present invention relates to a spreadable butter product and package for handling an individual service portion of the spreadable butter product. More specifically, the present invention is directed towards the composition and method of forming the spreadable butter product.

### BACKGROUND OF THE INVENTION

Portioned butter has been pre-packaged, sold to and used by the great majority of eating establishments in small rectangles, called pats. At present, spreadable materials, such as butter and margarine, are packaged and are commercially available in a variety of individual service portions. In one such package, a preformed rectangular shape or pat of butter or margarine is placed on a base card and a flat piece of wax paper is placed over and stuck to the pat. The pat is covered on the top and bottom but not on the sides. The spreadable product is readily removed from the base card by the user in amounts to suit the user's requirements with a butter knife after the cover has been peeled off. Such packaging is commercially used to a large extent. However, the spreadable material is not fully enclosed in the package nor is the package sealed. Despite their enormous commercial success, these packages suffer the disadvantage that they are open on four sides, permitting the passage of air about the butter, and thus could become contaminated by dirt, bacteria, oxidation or the like.

In another commercial package, the pat is completely wrapped in foil. This package requires the user to unwrap the foil which invariably results in the user getting some of the spreadable material on his fingers. In addition to being a slight annoyance, this is messy and wastes product. Furthermore, because the wrapping material is quite flexible, it is usually necessary to place the opened package on a flat surface such as a table and to scrape the spreadable material from the paper. The flexible wrapper does not provide a convenient base from which suitable amounts of the material can be removed for use. Moreover, such packages require about nine square inches of foil. This amount of foil is not only expensive but creates a problem of disposing of the wrap after the pat has been unwrapped. This is awkward, unsightly, and a further annoyance while dining. Additionally, once the wrapped pats are brought to room temperature, they can become impressed by users and must be discarded.

Further present commercial embodiments include butter contained in a rigid plastic cup covered with foil. The packages often waste butter due to the user's inability to remove all the contents therein.

The present invention pertains to packaging butter-like foodstuffs in individual squeeze packets. Various condiments, such as ketchup, mustard, mayonnaise, honey, relish, and others, have been available in single serving squeeze packets. The squeeze packets are commonly fashioned of two rectangular sheets of flexible plastic material generally about an inch to an inch and a half by three or four inches. The packets are heat sealed around their periphery to create a condiment-holding, heat-sealed squeeze packet. Of the multitude of condiments available in such squeeze packets, butter is noticeably absent.

The contents of a squeeze packet may be spread directly, simplifying application of the condiment and eliminating the need for a knife or a flat surface to place the butter prior to use.

Thus, there is a need for a package for a spreadable product, such as butter, in which the spreadable product is fully enclosed within the package but from which the product can be readily removed and spread. Such a package not only eases use of the condiment, but is easily handled, transported and stored. Moreover, there is a further need for a spreadable butter for use with such a package.

### SUMMARY OF THE INVENTION

The present invention provides an individual serving size of a spreadable butter product in a simplified package which eases use, provides for simple handling, transportation and storage, and also prevents contamination of the contents.

In accordance with the preferred embodiment of the present invention, a method for forming a viscous spreadable butter product is disclosed. The method includes the steps of heating a butter product to a temperature ranging from about 40° F. to about 80° F., aerating the butter product to contain at least 5% by volume air bubbles, and adding a preservative to the butter product to maintain freshness of the butter product at a room temperature.

In further accordance with the present invention, a squeezable packet containing a spreadable product butter is provided by placing the butter contents of each packet in between at least two laminate layers of a material such as foil, plastic, or a combination of desired materials, the layers capable of being heat sealed, radio frequency welded, or the like. The at least two layers are sealed on at least three sides of the butter serving, enveloping the contents in a sealed package. In one embodiment, the sealing process forms a sheet structure having a plurality of individual pockets for butter. The sheet structure is then cut along the sealed areas that surround each pocket, forming individual packets of individual servings of butter. A zigzag pattern may be cut into the top and bottom sides to allow the packet to be easily torn open.

### BRIEF DESCRIPTION OF THE FIGURES

FIG. 1 is a top view illustration of the preferred embodiment of the present invention.

FIG. 2 is a cross sectional view illustration of section AA from FIG. 1 of the preferred embodiment of the present invention.

FIG. 3 is a diagrammatic illustration of the process of the present invention.

### DETAILED DESCRIPTION OF THE PREFERRED EMBODIMENT

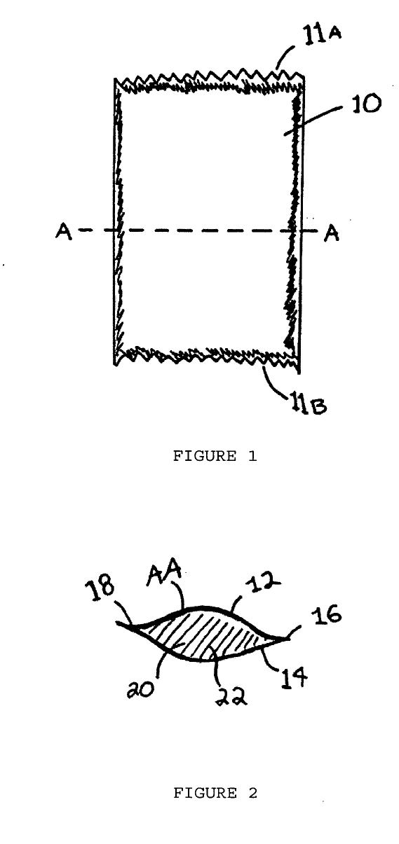

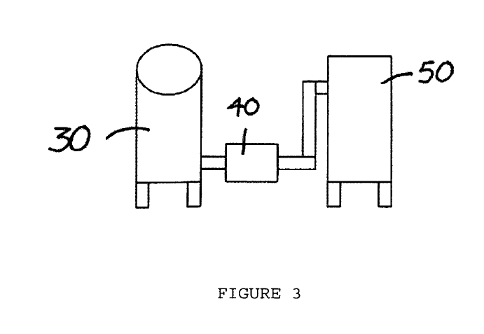

Referring to FIG. 1, a preferred embodiment of the present invention is illustrated as an individual serving packet of butter 10 with a pattern cut top 11a and pattern cut bottom 11b. Packet 10 ranges from about one and a half to three and a half inches in length by about one half to two and a half inches in width. Pattern cut top 11a and bottom 11b of the packet 10 allows the package to be easily torn open for use of the product.

Referring now to FIG. 2, a cross sectional view of section AA from FIG. 1, individual serving packet 10 includes a top layer of a sealable material 12, a bottom layer of a sealable material 14, peripheral seals surrounding the entirety of the packet 16 and 18, cavity 20, and spreadable butter product 22 of packet 10.

The material forming top and bottom layers 12 and 14 of packet 10 is preferably composed of a foil-plastic combination that allows susceptibility to heat sealing or other welding of the plastic component while the foil component provides structural stability and a degree of rigidity for handling and tearing open of packet 10. Seals 16 and 18 form a completely sealed perimeter around the contents of the package, forming cavity 20 and creating an airtight seal to prevent contamination and ensure the preservation of the spreadable contents while in storage or transportation.

The contents of packet cavity 20 preferably include a softened, spreadable butter product 22. Butter product 22 is formed by placing large solid butter pieces into a piston driven chopper that cuts the large butter block into smaller pieces. The small butter pieces are then placed into a container or mixing tank 30 capable of being heated where butter product 22 is then heated to a temperature preferably ranging from about 40° F. to about 85° F., most preferably in a range from about 80° F. to about 85° F. This preferred temperature range ensures that butter product 22 is softened into a viscous state, but does not separate butter product 22 into its oil and cream components.

Once butter product 22 is entered into the heating process, it is aerated. Such aeration may result from agitation by a mixer at a rate sufficient to aerate butter product 22. Such a rate can range upwards of 3 rotations per minute (RPM), and is preferably about 6 RPM.

A preservative, preferably butylated hydroxytolulene (BHT), is then added to butter product 22 in a range from about 0.01 ounce per 100 pounds of butter product 22 to about 5 ounces per 100 pounds of butter product 22. The preservative ensures the freshness of the butter after it is sealed into a packet and left at a room temperature for lengthy periods of time, thereby reducing or eliminating the need to refrigerate the butter packet. In particular, BHT is a phenolic compound that can be used to preserve fats; including fats found in butter. BHT is an antioxidant, causing oxygen to preferentially react with itself rather than fats or oils, thus retarding spoilage.

Butter product 22 is then transferred from the container by way of a diaphragm pump 40 into a packet-injecting portion 50 of the process. While butter product 22 is transported from the container 30, air bubbles can also be added to butter product 22 by means of an air seepage valve in diaphragm pump 40, resulting in a softened butter product having at least about 3% of the total volume of butter product 22 composed of air bubbles. Preferably, the air bubbles make up at least about 5% of the total volume of butter product 22, most preferably the air bubbles make up at least about 10% of the total volume of butter product 22.

Advantageously, the aeration process makes butter product 22 softer and easier to spread.

Butter product 22 is subsequently deposited into an individual packet 10 by a plunger-driven dispenser or similar device. Each butter packet 10 is made of a three-layer heat-sealable film that can be sealed by a low heating temperature. The low temperature used to seal packet 10 further ensures that butter product 22 is not heated to the point of separation, as discussed aboye. Packet 10 is sealed on two sides prior to the addition of butter product 22, leaving only a single opening in packet 10 requiring sealing after butter product 22 is placed therein. The packet sealing process includes the contacting of heating elements on either side of open packet end for a duration of time sufficient to result in a pressed, sealed end of the packet. The heating elements are then displaced from the contact position and the individual softened butter packet 10 is completed and ready for use.

1. A method for forming a viscous spreadable butter product, said method comprising the steps of;
heating a butter product to a temperature of less than about 85° F.;
aerating said butter product to contain at least about 5% by volume air bubbles; and
adding a preservative to said butter product to maintain freshness of said butter product at a room temperature.

2. The method according to claim 1, said method further including the step of packaging said butter product in a single use packet.

3. A method for forming a viscous spreadable butter product, said method comprising the steps of;
heating a butter product to a temperature of less than about 85° F.;
aerating said butter product through agitation so as to contain at least about 5% by volume air bubbles; and
adding a preservative to said butter product to maintain freshness of said butter product at a room temperature.

4. The method according to claim 1, wherein the preservative is butylated hydroxytolulene.
